(19) United States
(12) Patent Application Publication
(10) Pub. No.: US 2023/0172120 A1
(43) Pub. Date: Jun. 8, 2023

(54) Mechanically Assisted Horizontal Trellis System

(71) Applicant: Bobby Mitchell, Lumberton, MS (US)

(72) Inventor: Bobby Mitchell, Lumberton, MS (US)

(21) Appl. No.: 17/687,212

(22) Filed: Mar. 4, 2022

Related U.S. Application Data
(60) Provisional application No. 63/285,816, filed on Dec. 3, 2021.

(51) Int. Cl. A01G 9/12

(52) U.S. Cl. CPC A01G 9/12

(57) ABSTRACT

The mechanically assisted horizontal trellis system is a device intended to help support plant weight and facilitate more simplistic methods for erection and removal of a horizontal trellising system. In other words, the device can easily extend and retract to form a grid system to support a variety of plant heights and sizes. In order to accomplish this the device includes a plurality of legs that are designed to hold a grid frame above or next to the plants growing in a variety of ways. Further, the plurality of frame tubes is equipped with retractable devices that allow the user to easily assemble and disassemble the grid system. More specifically, the device includes retractable cable and fastener system that may be easily and efficiently assembled and disassembled to create the grid system to support plants and flowers without damaging or disturbing the plants or flowers.

### FIELD OF THE INVENTION

The present invention relates generally to a mechanically assisted system for horizontal trellising. More specifically, the present invention is a device that utilizes retracting mechanical devices to create a horizontal grid pattern for plant training and manipulation.

### BACKGROUND OF THE INVENTION

Within the agricultural industry technology has adapted and grown to grow plants and ensure they stay healthy more efficiently. The Screen of Green method (SCROG) or horizontal trellising is a technique used to manipulate plant growth and optimize the plant yield per square foot. The SCROG method manipulates the plant branches by encouraging them to grow horizontally to expose the flower nodes to the light source creating a more vigorous plant growth. Unfortunately, the current SCROG methods available within the industry require extensive time, labor and can potentially damage the plants during the installation or removal of the devices used. Currently, many individuals need to tediously remove trellis netting or other grid support structures or completely destroy the synthetic mesh screen, ridged grid r any other form of grid support that is intertwined around the plants. These grids can sometimes require multiple people taking care to not damage the plants and flowers while removing the material.

An objective of the present invention is to provide users with a mechanically assisted linear grid system, to help support plant weight and facilitates more simplistic methods for erection and removal of a horizontal trellising system. In other words, the present invention intends to provide users with a device that can easily extend and retract to form a grid system to support a variety of plant heights and sizes. In order to accomplish this, the present invention comprises a plurality of legs that are designed to hold a grid frame above or next to the plants growing in a variety of ways. Further, the plurality of frame tubes is equipped with self-retracting devices to allow the user to easily assemble and disassemble the grid system. More specifically, the present invention comprises retractable cable and fastener systems that may be easily and efficiently assembled and disassembled to create the grid system to support plants and flowers without damaging or disturbing the plants or flowers. As a result, the present invention assists plants in horizontal and vertical growth with increase in light penetration to the plant.

### BRIEF DESCRIPTION OF THE DRAWINGS

FIG. 1 is a top-front-left perspective view of the present invention.

FIG. 2 is a right-side elevational view of the present invention, wherein a first frame tube and two legs are shown.

FIG. 3 is a top-plan view of the present invention.

FIG. 4 is a bottom perspective view of the present invention, wherein a plurality of hanging hooks is mounted onto terminal ends of the legs.

FIG. 5 is a top-plan view of the present invention, wherein hooks that latch onto frame tubes are used as fasteners.

FIG. 6 is a perspective view of the present invention, wherein a plurality of grid systems is laterally attached to create an extended and multi-tiered horizontal trellis system.

FIG. 7 is a top perspective view of a frame tube, wherein a protective cover is wrapped around the frame tube.

FIG. 8 is a top plan view of the frame tube in FIG. 7.

FIG. 9 is an exploded view of FIG. 7.

### DETAIL DESCRIPTIONS OF THE INVENTION

All illustrations of the drawings are for the purpose of describing selected versions of the present invention and are not intended to limit the scope of the present invention.

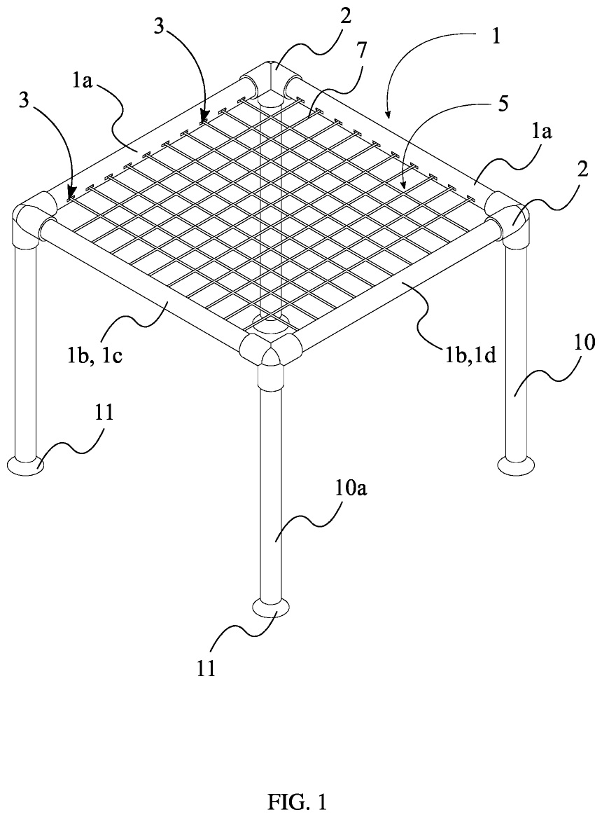

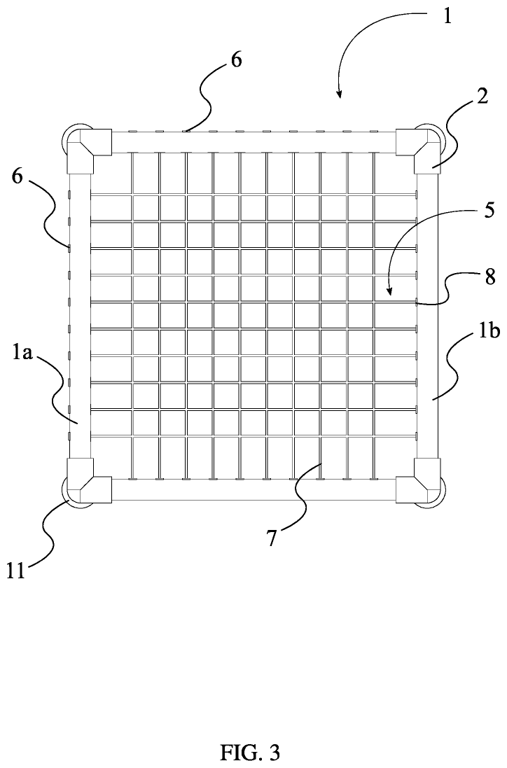

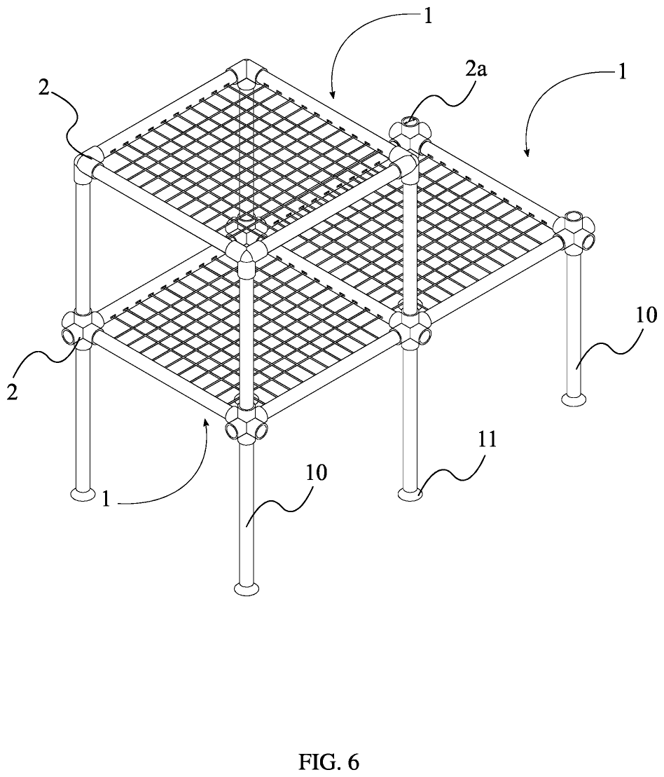

In reference to FIG. 1 through FIG. 9, the present invention is a mechanically assisted horizontal trellis system. It is an objective of the present invention to provide users with a device, that can help support plant weight and facilitates more simplistic methods for erection and removal of a horizontal trellising system. In other words, the present invention intends to provide users with a device that can easily extend and retract to form a grid system to support a variety of plant heights and sizes. In order to accomplish this, the present invention comprises a plurality of legs that are designed to hold a grid frame above or next to the plants growing in a variety of ways. Further, the plurality of frame tubes is equipped with retractable devices to allow the user to easily assemble and disassemble the grid system. More specifically, the present invention comprises retractable cable and fastener devices that may be easily and efficiently assembled and disassembled to create the grid system to support plants and flowers without damaging or disturbing the plants or flowers. As a result, the present assists plants in horizontal and vertical growth with increase in light penetration to the plant.

The following description is in reference to FIG. 1 through FIG. 9. According to a preferred embodiment, the present invention comprises a frame 1, a plurality of connectors 2, a plurality of slots 3, a plurality of retracting devices 4, and a grid 5. Preferably, the frame 1 comprises a plurality of first frame tubes 1a and a plurality of second frame tubes 1b. As seen in FIG. 1 through FIG. 9, the plurality of first frame tubes 1a and the plurality of second frame tubes 1b are cylindrical hollow tubes made of a sturdy material such as steel. However, the plurality of first frame tubes 1a and the plurality of second frame tubes 1b may comprise any other shape, size, orientation, components, and arrangement of components that are known to one of ordinary skill in the art, as long as the objectives of the present invention are fulfilled. More specifically, the plurality of first frame tubes 1a and the plurality of second frame tubes 1b may be made of any rigid material with a cylindrical, square or rectangular shape.

In the preferred embodiment, the plurality of connectors 2 connect terminal ends of the plurality of first frame tubes 1a and terminal ends of the plurality of second frame tubes 1b, to form the frame 1. The plurality of connectors 2 is designed with a similar rigid steel material that creates a corner connection between the plurality of first frame tubes 1a and the plurality of second frame tubes 1b. More specifically, each of the plurality of first frame tubes 1a is positioned opposite to a corresponding tube 1c, wherein the corresponding tube 1c is from the plurality of second frame tubes 1b. Accordingly, as seen in FIG. 1 through FIG. 6, the plurality of first frame tubes 1a and the plurality of second frame tubes 1b are connected and arranged in a rectangular/square shape to form the frame 1.

In order to house the plurality of retracting devices 4 in a safe and secure way, the plurality of slots 3 laterally traverses through each of the plurality of first frame tubes 1a. This is so that the plurality of retracting devices 4 may be mounted within the plurality of slots 3. The plurality of retracting devices 4 is secured within the plurality of first frame tubes 1a to limit the amount of protruding material. However, the plurality of retracing devices 4 may be mounted onto or within the plurality of first frame tubes 1a using any other mounting technology and/or devices that are known to one of ordinary skill in the art, as long as the intents of the present invention are not altered. Examples of such techniques include, but are not limited to the strapping, hanging, attaching with a screw, using adhesives etc. Preferably, the plurality of slots 3 are rectangular or elliptical slots that are positioned along a length of each of the plurality of first frame tubes 1a and are equally spaced out. However, the plurality of slots 3 may comprise any other shape, orientation, components and arrangement of components, as long as the intents of the present invention are not altered.

According to the preferred embodiment, the grid 5 is mounted within the frame 1. As seen in FIG. 1 through FIG. 9, this is made possible because the plurality of retracting devices 4 laterally connect each of the plurality of first frame tubes 1a to an opposing tube 1d to form the grid, wherein the opposing tube 1d is from the plurality of second frame tubes 1b. In other words, each of the retracting devices 4 connects one frame tube to an opposing frame tube laterally and helps with the formation of the grid 5.

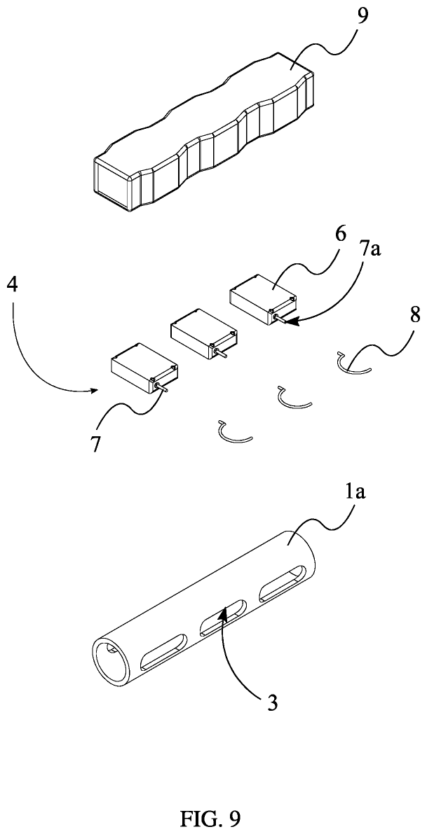

In order to accomplish an easily attachable and detachable lateral grid formation, each of the plurality of retracting devices 4 comprises a body 6, a retractable cable 7, and a fastener 8. As seen in FIG. 9, the body 6 is a rectangular receptacle that can house the retractable cable 7 spun around a spool and may house any other mechanical components for the smooth functioning of the retracting device 4. That is, the retractable cable 7 is mounted within the body 6 when not being in use or being pulled out. However, the body 6 may comprise any other shape, components and arrangement of components that are known to one of ordinary skill in the art, as long as the intents of the present invention are not altered. Preferably, majority of the body 6 of the plurality of retracting devices 4 is concealed within the plurality of first frame tubes 1a. This is so that there are lesser protruding components on the frame.

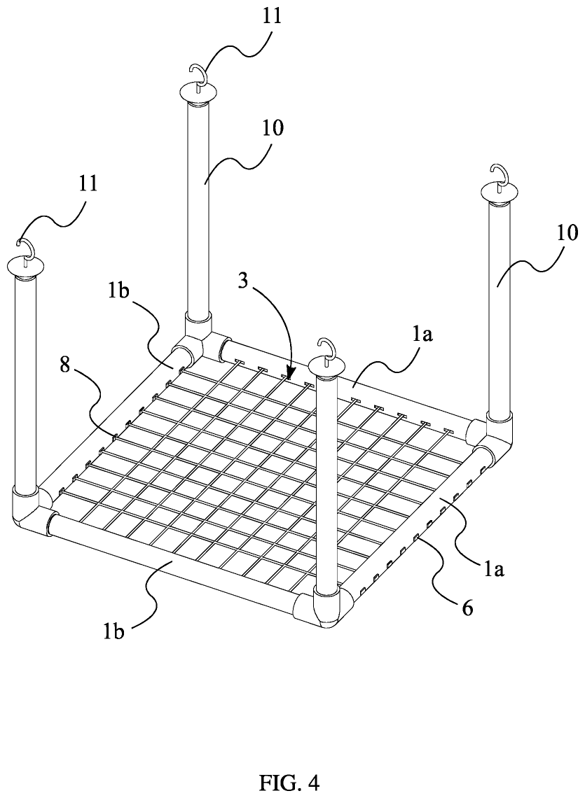

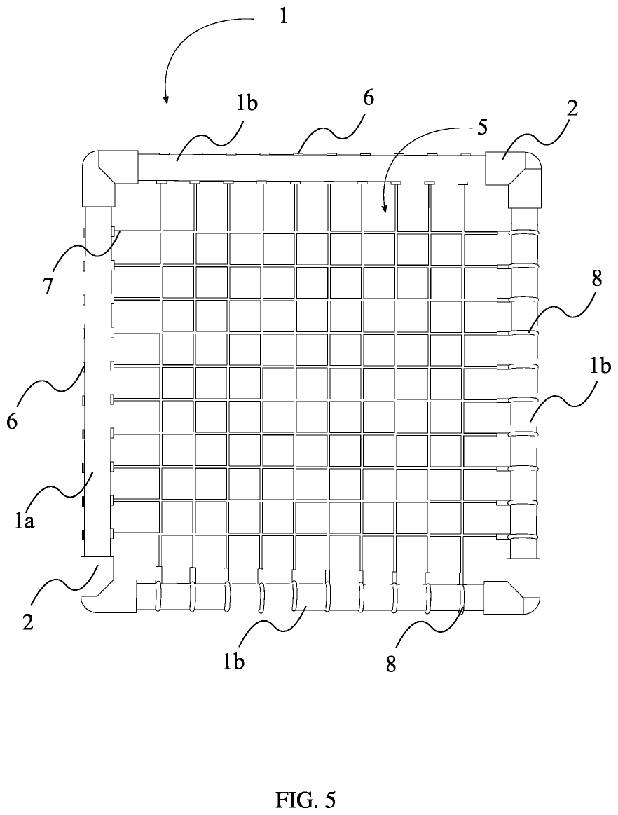

Further, the retractable cable 7 is made with a flexible and sturdy metal wire that uncoils and extends the length or width of the present invention, reaching the opposing frame tube. However, any other material, dimension, and shape may be used for the retractable cable 7, as long as the objectives of the present invention are fulfilled. Furthermore, as seen in FIG. 5 and FIG. 7 through FIG. 9, the fastener 8 is a hook that is mounted onto a terminal end 7a of the retractable cable 7. This is so that, the fastener 8 may hook the retractable cable 7 coming from the retracting device 4 mounted within the first frame tube 1a onto an opposing tube 1d . In other words, the fastener 8 is detachably mounted onto the opposing tube 1d, wherein the opposing tube 1d is from the plurality of second frame tubes 1b. However, the fastener 8 may comprise any other shape, size, technology etc. that are known to one of ordinary skill in the art, as long as the intents of the present invention are not altered. Examples of such fasteners include, but are not limited to snap on fasteners, d-clips, magnetic fasteners, hook and loop fasteners, etc. Further, the fastener may be concealed within the plurality of second frame tubes, or may be magnetic, as seen in FIG. 1 and FIG. 4. The design of the present invention allows the plurality of retracting devices 4 to extend perpendicularly from one frame tube to another creating a grid 5 as seen in FIG. 1 and FIG. 4. Thus, according to the present invention, the grid 5 is delineated by the retractable cables 7 from the plurality of retracting devices 4, connected between the plurality of first frame tubes 1a and the plurality of second frame tubes 1b.

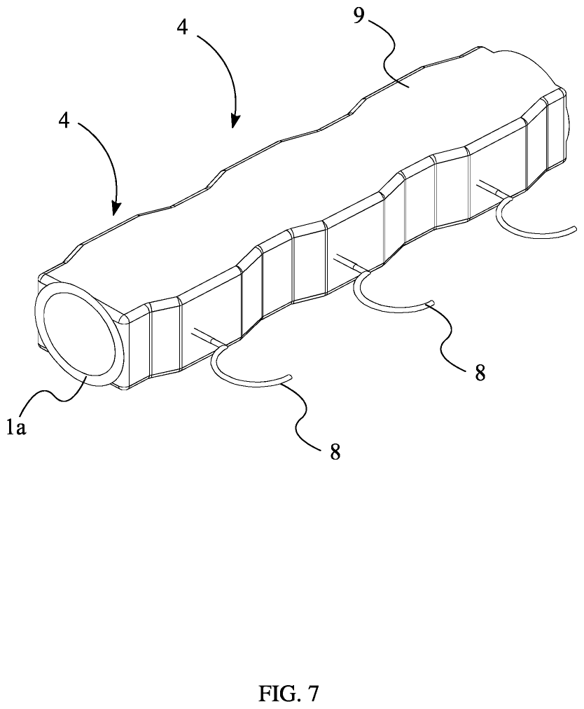

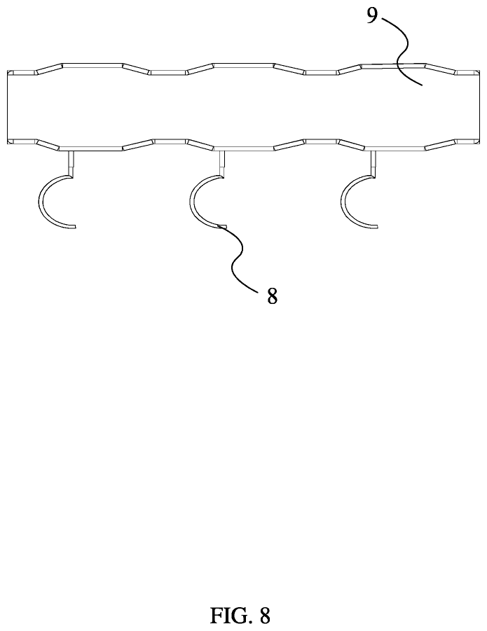

In reference to FIG. 7 through FIG. 9, the present invention comprises a protective cover 9. This is so that, the plurality of retracting devices 4 stay secured within the plurality of first frame tubes 1a. Accordingly, the protective cover 9 is wrapped around protruding portions of the body 6 of the retracting device 4. Further, as seen in FIG. 7 and FIG. 8, the protective cover 9 covers each of the plurality of slots 3, wherein the retractable cable 7 and the fastener 8 traverse through the protective cover 9 to fulfill their functionalities. Furthermore, the protective cover 9 may cover just the area around the plurality of retracting devices 4 or may cover the entire length of the plurality of first frame tubes 1a. Preferably, the protective cover 9 is a heat shrink wrap or polyethylene coat. However, any other materials, components, arrangement of components, covering mechanisms etc. may be employed for the protective cover 9, as long as the intents of the present invention are not altered.

According to the preferred embodiment, the present invention is supported by a plurality of legs 10. Preferably, the plurality of legs 10 is made of a rigid steel material with a cylindrical, square or rectangular shape. However, the plurality of legs 10 may comprise any other shape, material etc. as long as the intents of the present invention are not hindered. As seen in FIG. 1, the plurality of legs 10 is mounted on to terminal edges of the frame 1, and the plurality of legs 10 extends normally from the frame 1. In other words, the plurality of legs 10 is positioned at four corners of the frame 1 in a vertical fashion around the desired plants. In the preferred embodiment, the plurality of legs 10 come in various lengths that may be connected together to add vertical height. To that end, the plurality of connectors 2 connects the plurality of legs 10 to the frame 1. The plurality of connectors 2 is preferably designed with a 4-pronged cylindrical receiver to allow for a leg to be secured and two frame tubes to be secured with each component being perpendicular to each other forming a 90-degree corner. This design allows the plurality of legs 10 and plurality of first frame tubes 1a and the plurality of second frame tubes 1b to connect to one another to form a square or rectangular shape as shown in FIG. 5. In alternative embodiments, each of the plurality of connectors 2 may comprise four or more prongs each being perpendicular to each other to allow for horizontal or vertical expansion of the present invention. Further, the plurality of connectors 2 may comprise adjusting mechanisms that allows for the grid 5 to be fixed at any given height and enables the grid to be raised or lowered in height to accommodate various sized plants. In order to adjust the height of the frame 1 along the length of the plurality of legs 10, the plurality of connectors 2 is slidably and detachably mounted onto the plurality of legs 10. To that end, an inner diameter 2a of operation of each of the plurality of connectors 2 is adjustable. In other words, the plurality of connectors 2 may be tightened or loosened around the diameter of the plurality of legs 10 by means of screws or adjustable threads, such that the frame 1 may be slid up and down along the plurality of legs 10, based on the desired height of the plant. However, it should also be noted that, the plurality of connectors 2 may comprise any other technology, components, or arrangement of components that are known to one of ordinary skill in the art, as long as the intents of the present invention are not altered.

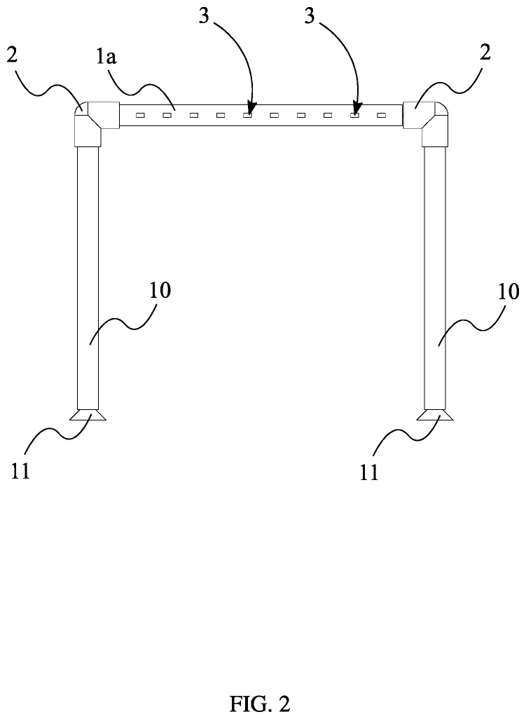

Continuing with the preferred embodiment, the present invention comprises a plurality of footings 11, wherein each of the plurality of footings 11 is terminally mounted onto a corresponding leg 10a, wherein the corresponding leg 10a is from the plurality of legs 10. As seen in FIG. 1, FIG. 2, and FIG. 5, the plurality of footings 11 may be rubber bushings that are conical in shape. The plurality of footings 11 ensures the plurality of legs 10 stay positioned once the present invention is assembled around a plant. However, in alternative embodiments, each of the plurality of footings 11 may be designed as a hook, wheel, loop, or adjustable base plate. These alternative embodiments allow the present invention to be repositioned easily, be positioned on flat ground or even be hung from a rack, frame or ceiling in a manner where the device hangs freely above the plants canopy. In reference to FIG. 4 the plurality of footings 11 is hanger loops.

Although the invention has been explained in relation to its preferred embodiment, it is to be understood that many other possible modifications and variations can be made without departing from the spirit and scope of the invention as hereinafter claimed.

What is claimed is:

1. A mechanically assisted horizontal trellis device comprising:
a frame;
a plurality of connectors;
a plurality of slots;
a plurality of retracting devices;
a grid;
the frame comprising a plurality of first frame tubes and a plurality of second frame tubes;
the plurality of connectors connecting terminal ends of the plurality of first frame tubes and terminal ends of the plurality of second frame tubes, forming the frame;
each of the plurality of first frame tubes being positioned opposite to a corresponding tube, wherein the corresponding tube is from the plurality of second frame tubes;
the plurality of slots laterally traversing through each of the plurality of first frame tubes;
the plurality of retracting devices being mounted within the plurality of slots;
the grid being mounted within the frame; and
the plurality of retracting devices laterally connecting each of the plurality of first frame tubes to an opposing tube, forming the grid, wherein the opposing tube is from the plurality of second frame tubes.

2. The mechanically assisted horizontal trellis device of claim 1, wherein each of the plurality of retracting devices comprising:
a body;
a retractable cable; and
a fastener;
the fastener being mounted onto a terminal end of the retractable cable; and
the retractable cable being mounted within the body when not being pulled out.

3. The mechanically assisted horizontal trellis device of claim 2, the fastener being detachably mounted onto the opposing frame, wherein the opposing frame is from the plurality of second frame tubes.

4. The mechanically assisted horizontal trellis device of claim 2, wherein the grid being delineated by the retractable cable from the plurality of retracting devices, connected between the plurality of first frame tubes and the plurality of second frame tubes.

5. The mechanically assisted horizontal trellis device of claim 2, wherein the fastener being a hook.

6. The mechanically assisted horizontal trellis device of claim 2, wherein the retractable cable being a metal wire.

7. The mechanically assisted horizontal trellis device of claim 2, wherein the body of the retracting device being concealed within the plurality of first frame tubes.

8. The mechanically assisted horizontal trellis device of claim 2, comprising:
a protective cover;
the protective cover being wrapped around protruding portions of the body of the retracting device;
the protective cover covering each of the plurality of slots; and
the retractable cable and the fastener traversing through the protective cover.

9. The mechanically assisted horizontal trellis device of claim 1, comprising:
a plurality of legs;
a plurality of footings;
the plurality of legs being mounted on to terminal edges of the frame;
the plurality of legs extending normally from the frame;
the plurality of connectors connecting the plurality of legs to the frame; and
each of the plurality of footings being terminally mounted onto a corresponding leg, wherein the corresponding leg is from the plurality of legs.

10. The mechanically assisted horizontal trellis device of claim 9, wherein the plurality of footings being rubber bushings.

11. The mechanically assisted horizontal trellis device of claim 9, wherein the plurality of footings being hanger loops.

12. The mechanically assisted horizontal trellis device of claim 9, wherein the plurality of connectors being slidably and detachably mounted onto the plurality of legs.

13. The mechanically assisted horizontal trellis device of claim 1, wherein an inner diameter of operation of each of the plurality of connectors being adjustable.

14. A mechanically assisted horizontal trellis device comprising:
a frame;
a plurality of connectors;
a plurality of slots;
a plurality of retracting devices;
a grid;
the frame comprising a plurality of first frame tubes and a plurality of second frame tubes;
the plurality of retracting devices comprising a body, a retractable cable, and a fastener;
the plurality of connectors connecting terminal ends of the plurality of first frame tubes and terminal ends of the plurality of second frame tubes, forming the frame;
each of the plurality of first frame tubes being positioned opposite to a corresponding tube, wherein the corresponding tube is from the plurality of second frame tubes;
the plurality of slots laterally traversing through each of the plurality of first frame tubes;
the plurality of retracting devices being mounted within the plurality of slots;
the grid being mounted within the frame;
the plurality of retracting devices laterally connecting each of the plurality of first frame tubes to an opposing tube, forming the grid, wherein the opposing tube is from the plurality of second frame tubes;
the fastener being mounted onto a terminal end of the retractable cable; and
the retractable cable being mounted within the body when not being pulled out.

15. The mechanically assisted horizontal trellis device of claim 14, the fastener being detachably mounted onto the opposing frame, wherein the opposing frame is from the plurality of second frame tubes.

16. The mechanically assisted horizontal trellis device of claim 14, wherein the grid being delineated by the retractable cables from the plurality of retracting devices, connected to the plurality of second frame tubes.

17. The mechanically assisted horizontal trellis device of claim 14, comprising:
a plurality of legs;
a plurality of footings;
the plurality of legs being mounted on to terminal edges of the frame;
the plurality of legs extending normally from the frame;
the plurality of connectors connecting the plurality of legs to the frame; and
each of the plurality of footings being terminally mounted onto a corresponding leg, wherein the corresponding leg is from the plurality of legs.

18. The mechanically assisted horizontal trellis device of claim 17, wherein the plurality of footings being hanger loops.

19. The mechanically assisted horizontal trellis device of claim 17, wherein the plurality of connectors being slidably and detachably mounted onto the plurality of legs.

20. The mechanically assisted horizontal trellis device of claim 14, comprising:
a protective cover;
the protective cover being wrapped around protruding portions of the body of the retracting device;
the protective cover covering each of the plurality of slots; and
the retractable cable and the fastener traversing through the protective cover.
